(19) United States
(12) Patent Application Publication
(10) Pub. No.: US 2025/0011936 A1
(43) Pub. Date: Jan. 9, 2025

(54) An Optimization Method to Achieve Energy Saving

(71) Applicant: Ah Eng Siaw, Johor Bahru (MY)

(72) Inventor: Ah Eng Siaw, Johor Bahru (MY)

(21) Appl. No.: 18/710,450

(22) PCT Filed: Oct. 27, 2022
(86) PCT No.: PCT/MY2022/050099

§ 371 Date: May 15, 2024

(30) Foreign Application Priority Data
Nov. 16, 2021 (MY) PI2021006799

(51) Int. Cl. C23C 24/00

(52) U.S. Cl. CPC C23C 24/00

(57) ABSTRACT

The present invention relates to a method of reducing energy loss from an electromechanical device comprising the steps of preparing a coating composition comprising a nano-sized particulate metal oxide, a binder and a liquid carrier, bombarding the composition with a vibration force at a frequency of 20-500 kHz for at least 24 hours so as to cause a state of energy excitation in atoms of the composition and coating the surface of the device or a casing surrounding the device with the composition.

### FIELD OF INVENTION

The present invention relates to an optimization method to achieve energy saving. More particularly, the present invention relates to a method of inducing electron vibration alignment in an electromechanical device to reduce energy loss as heat during flow of electricity.

### BACKGROUND OF THE INVENTION

Electricity has becoming an inescapable need for human and without electricity, human life would be in a chaos. However, electricity can be costly as the existing methods of generating electricity or electrical energy are mainly dependent on non-renewable resources. Recently, people are focusing on ways to minimise energy consumption or optimising energy usage, to reduce cost as well as to minimise negative impact to the environment as a result of extracting energy from the non-renewable resources.

More research effort has been put into finding ways to reduce energy usage or to efficient use of energy. Energy audit is done to identify possible reduction of energy input into a system without negatively affecting the performance or output. Energy saving material such as a superconductor, which has a higher electrical conductivity and lower electrical resistance, is also developed as an alternative to the conventional conductive material. Despite some reduction in energy usage can be achieved, a substantial amount of energy loss as heat is unavoidable due to random and irregular electron spin.

Electricity involves the flow of electrons within a closed electric circuit. Typically, the flowing electrons move in a free and irregular manner rather being flow in a straight path therefore collision between atoms of the circuit occur. A substantial amount of energy is lost as heat due to the irregular movement of the electrons before reaching a load. The degree of energy loss is also dependent on the specification of a conductive wire used such as, material, diameter, length, resistivity, and temperature.

In view of the above problems, there is a need to further optimise energy usage in which less energy is needed to drive an electric current as well as less energy is loss from irregular movement of electrons. Hence, it is desirable to develop a method of improving electrons flow or reducing irregular movement of electrons. This invention provides a solution to the problem.

### SUMMARY OF INVENTION

One of the objects of the invention is to provide an optimization method to achieve energy saving of an electromechanical device by coating a composition on a surface of the device.

Another object of the invention is to provide a use of a coating on a surface of an electromechanical device in which the coating can induce electron vibration alignment in the device thereby reducing energy loss or optimising energy consumption.

Still another object of the invention is to provide a composition for use in a coating on a surface of an electrochemical device in which the coating can induce electron vibration alignment therein.

Yet another object of the invention is to reduce the cost of electricity by reducing energy usage of an electromechanical device.

At least one of the preceding objects is met, in whole or in part, in which the embodiment of the present invention describes a method of reducing energy loss from an electromechanical device comprising the steps of preparing a coating composition comprising a nano-sized particulate metal oxide, a binder and a liquid carrier, bombarding the composition with a vibration force at a frequency of 20-500 kHz for at least 24 hours so as to cause a state of energy excitation in atoms of the composition and coating the surface of the device or a casing surrounding the device with the composition.

In a preferred embodiment of the present invention, it is disclosed that the electromechanical device is an electrical distribution board, a cable, surface of termination box, or surface of a junction box.

Preferably, the metal oxide is an oxide of aluminium, iron, magnesium, lithium, potassium, copper, tourmaline or a mixture thereof.

Preferably, the binder is acrylic polymer.

Preferably, the liquid carrier is a water.

More preferably, the water is reverse osmosis water or purified water.

In another preferred embodiment of the present invention, it is disclosed that the composition used in the method comprises 0.1 to 30 parts by weight of metal oxide, 0.1 to 10 parts by weight of binder and 50 to 90 parts by weight of liquid carrier.

Further embodiment of the present invention discloses that the thickness of the coating is at least 100 μm.

One skilled in the art will readily appreciate that the present invention is well adapted to carry out the objects and obtain the ends and advantages mentioned, as well as those inherent therein. The embodiment described herein is not intended as limitations on the scope of the invention.

### DETAILED DESCRIPTION OF THE INVENTION

The present invention relates to an optimization method to achieve energy saving. More particularly, the present invention relates to a method of inducing electron vibration alignment in an electromechanical device to reduce energy loss as heat during flow of electricity.

Hereinafter, the invention shall be described according to the preferred embodiments of the present invention and by referring to the accompanying description and drawings. However, it is to be understood that limiting the description to the preferred embodiments of the invention is merely to facilitate discussion of the present invention and it is envisioned that those skilled in the art may devise various modifications without departing from the scope of the appended claim.

The invention discloses a method of reducing energy loss from an electromechanical device comprising the steps of preparing a coating composition comprising a nano-sized particulate metal oxide, a binder and a liquid carrier, bombarding the composition with a vibration force at a frequency of 20-500 kHz for at least 24 hours so as to cause a state of energy excitation in atoms of the composition and coating the surface of the device or a casing surrounding the device with the composition.

In the preferred embodiment of the invention, energy loss in an electromechanical device such as, but is not limiting to, electrical distribution board, cable, termination box or junction box is reduced by coating any surface of the device with the composition which comprises a nano-sized particulate metal oxide, a binder and water.

The surface of the device may not be limited to any kind of material and, it can be made from glass, plastics material, metal, or rubber. Preferably, the coating has a thickness of at least 100 μm so as to sufficiently provide an advantageous effect to the device which will be described later. However, it is not necessary to have a coating thickness of more than 100 μm as additional thickness would have no or only minimal improvement in the advantageous effect.

The atoms of the coating hold sufficient energy which causes them to vibrate at a predetermined frequency similar to the natural frequency of the device for a period of time. When the surface of the device is coated, the atoms of the coating transferred the vibration energy to the atoms of the device, particularly the atoms of conductive wires, in all direction at a distance ranging from 0 mm to 300 mm. With that, the atoms of the device are induced to vibrate at a similar frequency. Particularly, the atoms of the device are vibrating at their natural frequency where resonance occurs. Electron vibration alignment on the affected area of the device occurs, in which randomly spinning electrons are forced to align and spin uniformly. Collision between atoms of the affected area of the device is minimised therefore, minimal energy loss as heat due to friction between atoms. Electrical resistivity of the device is reduced as well.

The composition can be coated evenly on the surface of the electromechanical device by any coating method for example, but is not limiting to, hand spray. It shall be noted that the surface to be coated shall be clean and free from solid impurities to enhance binding of the composition to the surface. After coating the composition on the surface, the coating can be cured at room temperature. Advantageously, the atoms of the composition shall hold the vibration energy for at least 12 months. Thereafter, recoating of the composition may be required.

According to the preferred embodiment of the invention, the composition comprises particles of metal oxide, preferably in a scale of nano size. Smaller particle size is preferred as larger surface area is provided for capturing, holding, and releasing of the vibration energy. The metal for the metal oxide can be selected from the group, but not limiting to, consisting of aluminium, iron, magnesium, lithium, potassium, copper, tourmaline or a mixture thereof. One skilled in the art shall not limit the metal oxide to one type of metal oxide; rather it can be a mixture of two or more types of metal oxide. High electrical conductivity metal is preferred as it can hold higher charge and therefore, higher ability and capacity to hold vibration energy of which thereafter is transferred to the coated device. Preferably, the composition comprises 0.1 to 50 parts by weight of metal oxide. The amount of energy transferred to induce resonance may not be sufficient for less than 0.1 parts by weight of metal oxide. However, any amount more than 50 parts by weight of metal oxide would not provide any additional advantageous effect.

The particles of metal oxide are contained within a liquid carrier so that the prepared composition is readily to be applied and coated on a surface. The liquid carrier also acts as a medium of transferring energy from an energy source to the metal oxide or from the metal oxide to the atoms of the device. Any kind of liquid carrier which does not react with the metal oxide can be used. Preferably, the liquid carrier is water. More preferably, the alcohol can be selected from reverse osmosis water or purified water. Preferably, the composition comprises 50 to 90 parts by weight of liquid carrier.

As described by the preferred embodiment of the invention, a binder is needed to ensure the coating binds well to the surface to be coated. Preferably, the binder is a acrylic polymer. More preferably, the acrylic polymer can be selected from poly methyl methacrylate, styrene, acrylate or methacrylate. Any acrylic binder which can render the composition be cured at room temperature and reduced curing time can be used. Preferably, the composition comprises 0.1 to 10 parts by weight of binder.

The composition for the use in the method as described in any of the preceding description can be produced with the following method. The metal oxide, binder and liquid carrier are homogeneously mixed one at a time. The order of mixing is preferred to be binder, liquid carrier, and metal oxide. It shall be noted that metal oxide shall not be added before liquid carrier in order to achieve a homogeneous mixture. More preferably, the composition is homogenised by an ultrasonic mixer operating at a frequency of 20 kHz to 40 kHz for at least 1 hour. However, it is not necessary to mix the composition for more than 2 hours to achieve a homogeneous mixture. Any other method of homogenising the mixture can be adopted. During the homogenisation, nano particulates metal oxide can be further broken down into smaller size with a higher surface area to capture, hold, and release the vibration energy.

Subsequently, the mixture is subjected to bombardment with a vibration force at a frequency of 20 kHz to 100 KHz for at least 24 hours to store energy within the nano-particles. The vibration force can be provided in any form. However, it shall be noted that the vibration force shall not be induced by any kind of magnetic field in which the magnetic energy held within the atoms of the composition may cause impairment on the device. Preferably, the vibration force is provided by an ultrasonic means. Sufficiently long period of bombardment time is required so as to allow atoms of the composition, particularly atoms of the metal oxide, to capture and hold the energy from the vibration force for a period of time. Atoms of the composition with the energy are excited to vibrate vigorously for a period of time at a frequency similar to the frequency of the vibration force.

The homogenisation step and bombardment step can be in a single operation in which only ultrasonic treatment is utilised. After mixing the composition, the mixture is subjected to ultrasonic treatment where homogenisation and energy capturing occur simultaneously. The ultrasonic frequency is preferably at 20 kHz to 100 KHz and the treatment is preferably last for at least 24 hours, more preferably for at least 48 hours. However, composition produced using single operation method is prone to have phase separation. Although phase separation may not affect the performance of the composition, the aesthetic view of the composition may not be welcome by the user.

Alternatively, the homogenisation step and bombardment step can be in two separate operations even only ultrasonic treatment is utilised. The binder and liquid carrier are mixed and homogenise by ultrasonic mixer at a frequency of 20 kHz to 40 kHz for at least 1 hour, preferably not more than 2 hours. Subsequently, metal oxide is added to the homogenised mixture. The resultant mixture is subjected to ultrasonic treatment at a frequency of 20 kHz to 100 kHz for at least 24 hours, more preferably for at least 48 hours.

### EXAMPLE

The following non-limiting example has been carried out to illustrate the preferred embodiments of the invention.

### Example 1

The composition as shown in Table 1 is mixed one by one. The mixture is subjected to ultrasonic treatment at a frequency of 50 kHz for 24 hours.

TABLE 1

| Material | Amount (parts by weight) |
|---|---|
| Acrylate | 15 |
| Water | 75 |
| Tourmaline | 10 |

### Example 2

The composition is as shown in Table 2. Acrylate, styrene and methanol are mixed one by one and homogenised in ultrasonic mixer at a frequency of 28 kHz for 1 hour. Copper oxide is added thereafter. The mixture is subjected to ultrasonic treatment at a frequency of 60 kHz for 24 hours.

TABLE 2

| Material | Amount (parts by weight) |
|---|---|
| Acrylate | 4 |
| Styrene | 5 |
| Water | 89 |
| Copper oxide | 2 |

### Example 3

The composition as shown in Table 3 is mixed one by one. The mixture is subjected to ultrasonic treatment at a frequency of 40 kHz for 24 hours.

TABLE 3

| Material | Amount (parts by weight) |
|---|---|
| Methacrylate | 5 |
| Acrylate | 4 |
| Water | 86 |
| Tourmaline | 2 |
| Aluminum oxide | 3 |

The composition is as shown in Table 2. Methacrylate, acrylate and water are mixed one by one and homogenised in ultrasonic mixer at a frequency of 30 kHz for 1 hour. Aluminium oxide and copper oxide are added thereafter. The mixture is subjected to ultrasonic treatment at a frequency of 40 kHz for 24 hours.

### Example 4

The composition used in Example 3 is coated on clean surfaces of a cable. The effect of the cable with and without coating on the electricity usage of four electrical circuits is tested.

The first and second circuits use a 240 V, 50 Hz single-phase alternative current supply. The voltage supplied to the circuit is maintained at 5 V for the first circuit whilst the electric current is maintained at 4.0 A for the second circuit. Two 30 cm long cable, one with coating and another without coating, are connected in parallel for the first circuit and in series for the second circuit. An ammeter and a voltmeter are connected to measure the electric current and voltage drop across the cables.

The electric current and voltage across the cables in the first and second circuits over a period of time are as shown in Table 4.

TABLE 4

| | First Circuit | | | Second Circuit | | |
|---|---|---|---|---|---|---|
| Date/Time | (I) - With | (I) - Without | | (I) Current | (V) - With | (V) - Without |
| Day 1 (12:00) | 4.00 A | 3.88 | A | 4.08 A | 41.0 mV | 60.3 mV |
| Day 1 (15:00) | 4.09 A | 3.910 | A | 4.069 A | 40.9 mV | 59.4 mV |
| Day 1 (17:10) | 4.07 A | 3.894 | A | 4.06 A | 40.5 mV | 60.1 mV |
| Day 2 (10:30) | 4.01 A | 3.863 | A | 4.04 A | 40.0 mV | 58.7 mV |
| Day 2 (14:00) | 4.05 A | 3.87 | A | 4.01 A | 40.2 mV | 59.0 mV |

For the first circuit, a higher electric current is obtained at a constant voltage for the cable with the coating. For the second circuit, a lower voltage drop is obtained at a constant electric current for the cable with the coating. The effect shown in both circuits indicated that the electrical resistivity of the cable with coating is reduced.

The third and fourth circuits use a 30 V direct current supply. The electric current is maintained at 3.0 A for the fourth circuit. Likewise, two 30 cm long cable, one with coating and another without coating, are connected in parallel for the third circuit and in series for the fourth circuit. An ammeter and a voltmeter are connected to measure the electric current and voltage drop across the cables.

The electric current and voltage across the cables in the third and fourth circuits over a period of time are as shown in Table 5 and Table 6 respectively.

TABLE 5

| Date/Time | (I) - With | (I) - Without |
|---|---|---|
| Day 1 (17:40) | 3.78 A | 3.06 A |
| Day 2 (09:00) | 4.05 A | 3.04 A |
| Day 2 (12:00) | 4.09 A | 3.15 A |
| Day 2 (17:00) | 4.08 A | 3.10 A |
| Day 3 (09:00) | 3.94 A | 3.14 A |
| Day 3 (12:05) | 4.09 A | 3.08 A |
| Day 3 (16:00) | 4.00 A | 2.97 A |

TABLE 6

| Date/Time | (I) Current | (V) - With | (V) - Without |
|---|---|---|---|
| Day 1 (17:15) | 3.04 A | 31.7 mV | 44.9 mV |

For the third circuit, a higher electric current is obtained at a constant voltage for the cable with the coating. For the fourth circuit, a lower voltage drop is obtained at a constant electric current for the cable with the coating. The effect shown in both circuits indicated that the electrical resistivity of the cable with coating is reduced.

The present disclosure includes as contained in the appended claims, as well as that of the foregoing description. Although this invention has been described in its preferred form with a degree of particularly, it is understood that the present disclosure of the preferred form has been made only by way of example and that numerous changes in the details of construction and the combination and arrangements of parts may be resorted to without departing from the scope of the invention.

1.-8. (canceled)

9. A method of reducing energy loss from an electromechanical device comprising the steps of:
preparing a coating composition comprising a nano-sized particulate metal oxide, a binder and a liquid carrier;
bombarding the composition with a vibration force at a frequency of 20-500 kHz for at least 24 hours so as to cause a state of energy excitation in atoms of the composition; and
coating the surface of the device or a casing surrounding the device with the composition.

10. The method according to claim 9, wherein the electromechanical device is an electrical distribution board, a cable, a surface of a termination box, or a surface of a junction box.

11. The method according to claim 9, wherein the metal oxide is an oxide of aluminum, iron, magnesium, lithium, potassium, copper, tourmaline or a mixture thereof.

12. The method according to claim 9, wherein the binder is an acrylic polymer.

13. The method according to claim 9, wherein the liquid carrier is water.

14. The method according to claim 13, wherein the water is reverse osmosis water or purified water.

15. The method according to claim 9, wherein the composition comprises 0.1 to 30 parts by weight of a metal oxide, 0.1 to 10 parts by weight of a binder and 50 to 90 parts by weight of a liquid carrier.

16. The method according to claim 9, wherein the thickness of the coating is at least 100 μm.
